(19) United States
(12) Patent Application Publication
(10) Pub. No.: US 2009/0266140 A1
(43) Pub. Date: Oct. 29, 2009

(54) Puncture-Resistant Containers and Testing Methods

(76) Inventor: Michael J. Fox, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 12/495,474

(22) Filed: Jun. 30, 2009

Related U.S. Application Data
(62) Division of application No. 12/053,209, filed on Mar. 21, 2008.

(51) Int. Cl. G01N 3/30

(52) U.S. Cl. 73/12.06

(57) ABSTRACT

A method and apparatus for testing a container for puncture resistance using a structure having a means to guide a dropper as the dropper freefalls and impacts with a pressurized container or a pressurized container freefalls and impacts with an impact target. An improved method of manufacturing a steel sheet having an isotropic metallurgical microstructure, the steel sheet being used to form a pressurized container with increased puncture resistance, wherein the improvement comprises heat treatment also is disclosed.

This is a divisional application of U.S. patent application Ser. No. 12/053,209, filed on Mar. 21, 2008, by the same inventor.

### FIELD OF THE INVENTION

The present invention relates in general to pressurized containers, and, more particularly, to a system and method of testing pressurized containers for puncture resistance and an improved method of manufacturing pressurized containers to increase their puncture resistance.

### BACKGROUND OF THE INVENTION

Several billion pressurized containers, or aerosols, are sold each year worldwide. Typical aerosol products include hairspray, air fresheners, spray paint, lubricants, deodorants, and cooking oils.

An aerosol includes the container and the contents inside the container. A propellant, such as but not limited to propane or butane, are added to the contents for the purpose of conveniently expelling the contents. The contents are why the consumer purchased the aerosol product and the container and the propellant are the means of packaging and delivery.

The most common type of aerosol container is the 3-piece steel container. The three pieces are: the top, the body, and the bottom. The body is typically formed by rolling and welding American Iron and Steel Institute/Society of Automobile Engineers (AISI/SAE) 1010 or similar steel sheet and the top and bottom are attached to the body via a double seam. The thickness of the body can vary, but the most common thicknesses are 0.007 and 0.008 inches.

Because the body is made from a rolled steel sheet, the microstructure of the body is most often asymmetric. The mechanical properties of the body are also directional, with the body being most likely to deform in the circumferential direction than in the longitudinal direction. In other words, the body wall is much less ductile in the length-wise direction than in the circumferential direction.

When an aerosol is dropped, the body of the container is susceptible to puncture. The likelihood of puncture depends on the distance of the fall, the nature of the object that the aerosol might strike, the orientation of the impact, and the aerosol's materials of construction. Due to the flammable nature of the propellants common to aerosols as well as other flammable contents, the accidental puncture of an aerosol can result in significant personal injury and property damage. While the U.S. Department of Transportation regulates several aspects of aerosol containers, there are no government regulations concerning puncture resistance. Likewise, there are no standard tests for the puncture resistance of aerosol containers.

A need exists for a method and system to effectively and reliably test the puncture resistance of aerosols and a method of manufacture which increases the resistance of aerosols to being punctured.

### SUMMARY OF THE INVENTION

In one embodiment, the present invention is a method of testing a container, and particularly a pressurized container in some applications, for puncture resistance, comprising positioning the container at the base of a chute, wherein the chute guides the fall of a dropper, adjusting a weight of the dropper, setting a drop height of the dropper using a movable dowel, wherein the dropper rests on the movable dowel inside the chute, and releasing the dropper by moving the movable dowel.

In another embodiment, the present invention is a method of testing a self-pressurized container for puncture resistance, comprising attaching the self-pressurized container to a plate, the plate being held to a top surface of a frame by an electromagnet, wherein the plate is made of a light weight material such as aluminum with a small piece of magnetic material in the center and is attached to guide wires, using a switch to control an electric current to the electromagnet, positioning an impact object under the self-pressurized container, and releasing the plate and attached container by turning off the electric current to the electromagnet.

In yet another embodiment, the present invention is a self-pressurized container testing system, comprising an enclosure, wherein the enclosure forms a chute and the enclosure has a plurality of opposing holes aligned in a first side and second side of the enclosure, the first side being opposite to the second side, a dropper having an adjustable weight, wherein the dropper is positioned above the self-pressurized container and the dropper is capable of falling through the chute, a movable dowel, the movable dowel being capable of being inserted into the plurality of opposing holes and supporting the weight of the dropper, and a string attached to an end of the dropper such that the string is capable of raising the dropper after the dropper has fallen.

In another embodiment, the present invention is a method of manufacturing a steel sheet having an isotropic metallurgical microstructure, the steel sheet being used to form a pressurized container with increased puncture resistance, wherein the improvement comprises heat treating the steel sheet for a predetermined time and temperature such that an equiaxed microstructure of the steel sheet results.

In another embodiment, the present invention is a method of manufacturing a steel sheet having an isotropic metallurgical microstructure, the steel sheet being used to form a self-pressurized container body with increased puncture resistance, the method of manufacturing the steel sheet, wherein the improvement comprises subjecting the steel sheet after the steel sheet is formed to a short-term high temperature recrystallization step.

### BRIEF DESCRIPTION OF THE DRAWINGS

The subject invention will be described in the context of the appended drawing figures, where the same numbers are used throughout the disclosure and figures to reference like components and features:

FIGS. 1a-1d illustrate schematic examples of how an aerosol might fall on an impact object, shown here as a table, creating an impact induced circumferential puncture;

FIG. 2 shows an actual impact induced circumferential puncture created by a falling aerosol in the manner shown in FIGS. 1c or 1d;

FIGS. 3a and 3b illustrate an implementation of a system for puncture testing an aerosol;

FIG. 4 illustrates another implementation of a system for puncture testing an aerosol.

FIG. 5 illustrates the effect on microstructure that heating had for the indicated time points.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

The present discussion considers the testing and manufacture of pressurized containers, or aerosols. In particular, a method and system for reliably testing the puncture resistance of an aerosol is presented. Further, an improved method of manufacturing the body of an aerosol container to increase puncture resistance is disclosed.

Drop impact tests have shown that a frequent mode of puncture is a circumferential crack. In one sense, these cracks are “punctures” because they result from the aerosol being impacted by an object, or visa versa. However, they are not “pure punctures” in the sense that the hole left behind has the shape of the object that the aerosol hit. For the purpose of this disclosure, a pure puncture is defined as one in which the opening left behind in the aerosol is a negative image of the object that the aerosol impacted. A puncture which is not in the shape of the puncturing object is defined as an impact induced circumferential puncture (IICP).

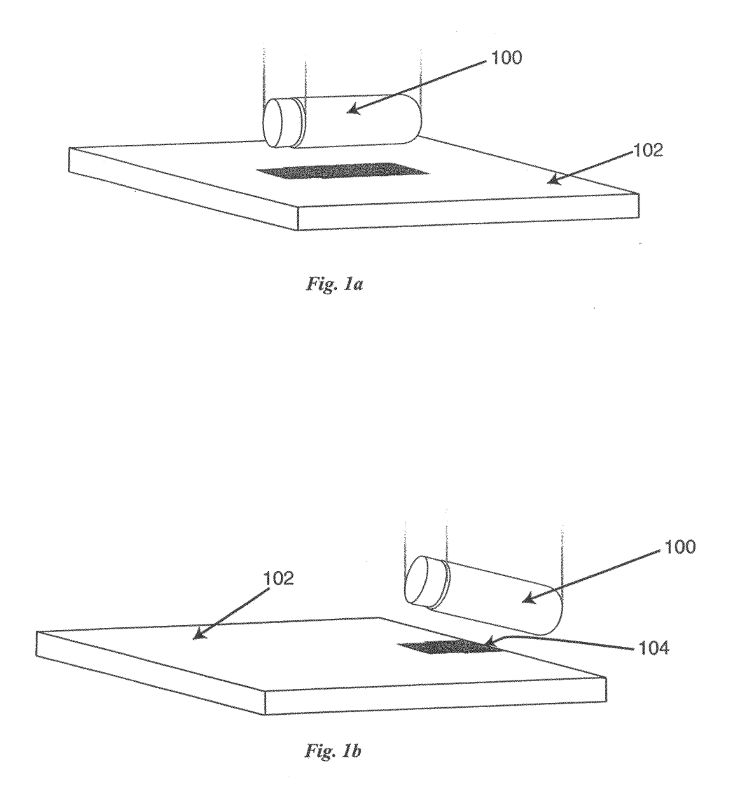

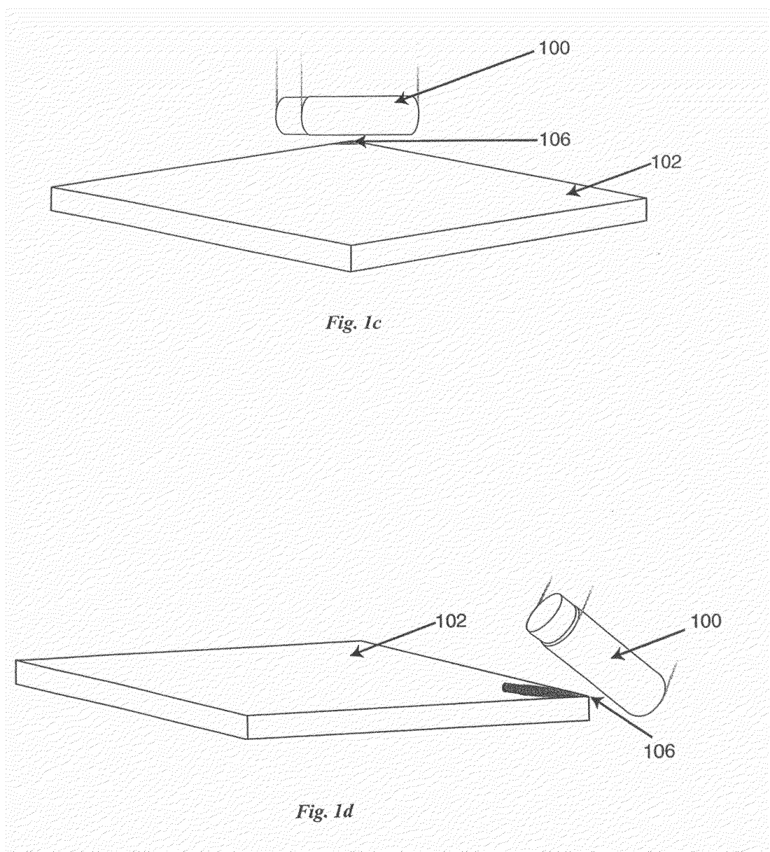

An example of a pure puncture would be an aerosol falling upon an upward pointing nail or the end corner of a piece of angel iron. In contrast, an example of an IICP would be an aerosol falling upon the corner of a table. For the purpose of discussion, FIGS. 1a-1d illustrate schematic examples of how an aerosol might fall and hit an impact object, here shown as a table, creating an IICP. It will be understood by one skilled in the art that the impact target may be an object other than a table without changing the principles discussed herein. Testing, using systems subsequently discussed, show that when an aerosol 100 falls completely flat, as in FIG. 1a, it is unlikely to puncture when it impacts a table 102. The same is true when aerosol 100 falls and hits a side edge 104 of table 102, as in FIG. 1b. However, when aerosol 100 falls and hits a corner 106 of table 102, as in FIG. 1c, there is a high probability that aerosol 100 will puncture. This probability is increased if aerosol 100 is rotating as it falls and impacts corner 106 at an angle, as in FIG. 1d.

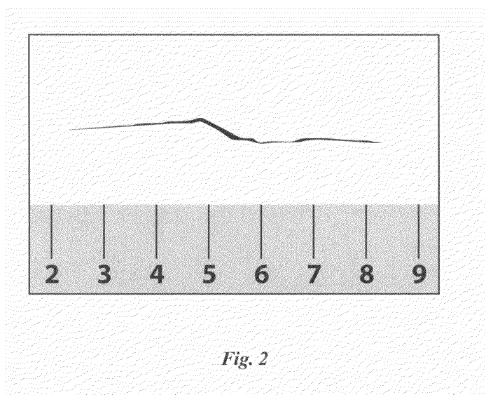

FIG. 2 shows an actual IICP created by a falling aerosol in the manner shown in FIGS. 1c or 1d. The IICP in FIG. 2 was caused by a fall from 14 inches onto a dull wood pyramid. An identical type of failure was caused by a fall from 4 feet onto a wood corner. The methods used to produce these punctures, and thus test the puncture resistance of an aerosol, will be discussed subsequently.

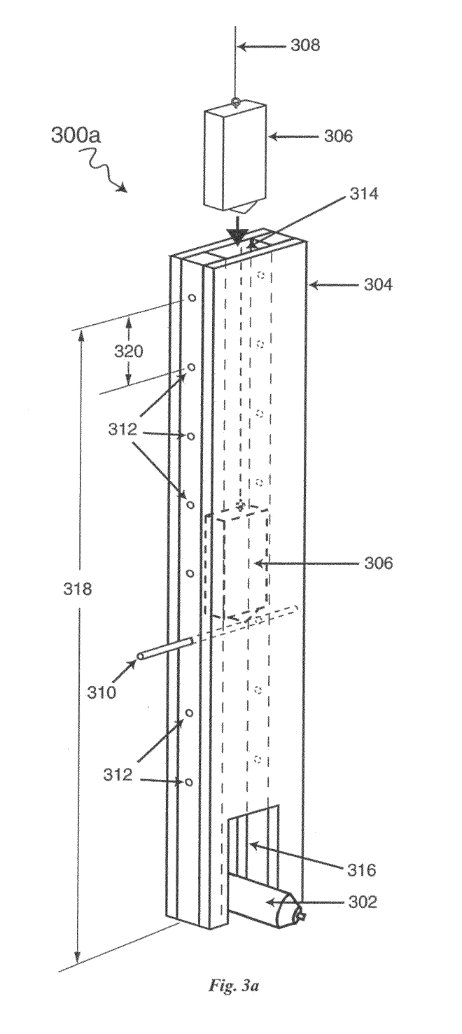

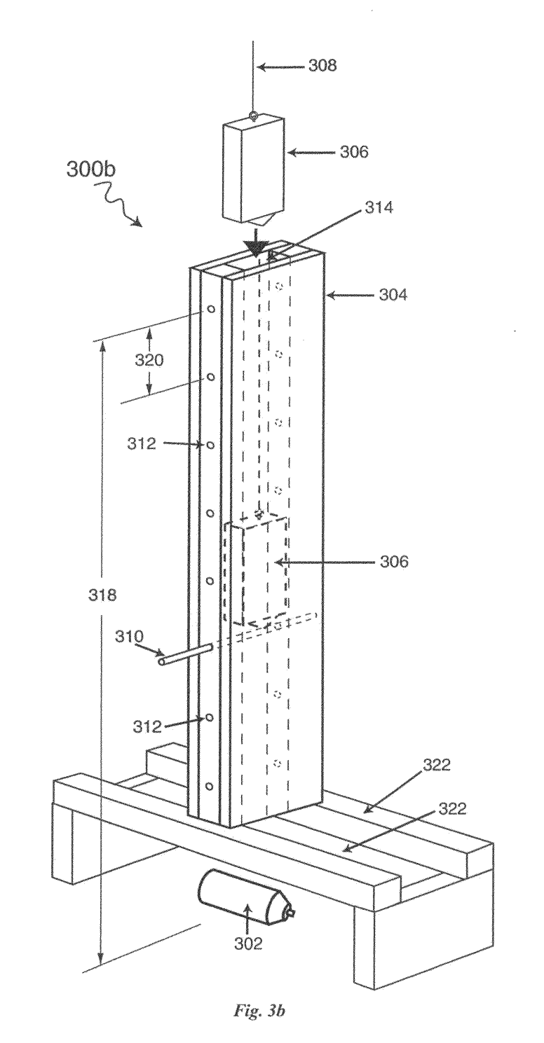

FIGS. 3a and 3b illustrate systems for puncture testing an aerosol where the aerosol itself is not moved. In the system 300a of FIG. 3a, an aerosol 302 is positioned in an opening 316 inside a structure 304 and directly under a chute 314. Structure 304 is illustrated as a rectangular box. However, a person skilled in the art will understand that other shaped structures could be used to achieve the same or similar results. Chute 314 is simply an opening through structure 304 and guides the freefall of a dropper 306 which, when released, impacts with aerosol 302. Dropper 306 may be made of various materials, for example wood, metal, plastic, or a combination thereof, and may take various forms. Aerosol 302 is able to move, but is slightly confined by the sides of structure 304.

The weight of dropper 306 can be adjusted and is usually set to the same weight of aerosol 302 being tested. In one implementation, the weight of dropper 306 is adjusted by adding or subtracting weights. In another implementation, multiple droppers are available for use, each dropper having a different weight. To adjust the weight, the specific dropper changed.

A drop height 318 is varied within chute 314 using a removable dowel 310. Structure 304 has multiple openings 312 aligned in opposing sides, dowel 310 fitting into openings 312 such that a portion of dowel 304 extends past the sides of structure 304. In one implementation, the openings are spaced at regular intervals 320. Dropper 306 rests on top of dowel 310 and, thus, drop height 318 can be changed by inserting dowel 310 into different openings 312. Dropper 306 is attached to a lightweight string 308, allowing dropper 306 be raised after each test and repositioned.

Different impact objects can be attached to the dropper thereby adding to the flexibility of the test method. The impact objects can be of any size, shape, or material needed to simulate the items which may puncture pressurized containers under everyday circumstances. By way of example, and not by way of limitation, such impact objects could include wooden blocks, metal cones, plastic rods, or any combination of materials and shapes. The impact object can also be attached to the dropper by any means practical such as, for example, by using ties, clamps, screws, bands, adhesives, or any combination thereof.

The system 300b of FIG. 3b for puncture testing an aerosol is similar to the system shown in FIG. 3a with the addition of a platform 322. Platform 322 is configured such that a structure 304 is raised above an aerosol 302. As in FIG. 3a, structure 304 contains a chute 314 which guides the freefall of a dropper 306 to impact with aerosol 302. A drop height 318 is varied within chute 314 using a removable dowel 310. Structure 304 has multiple openings 312 aligned in opposing sides, dowel 310 fitting into openings 312 such that a portion of dowel 304 extends past the sides of structure 304. Dropper 306 rests on top of dowel 310 and, thus, drop height 318 can be changed by inserting dowel 310 into different openings 312.

In system 300b, aerosol 302 is not confined by structure 304. This allows the aerosol to spin and self-propel, should that be of interest. For example, this freedom may be important in live fire test situations.

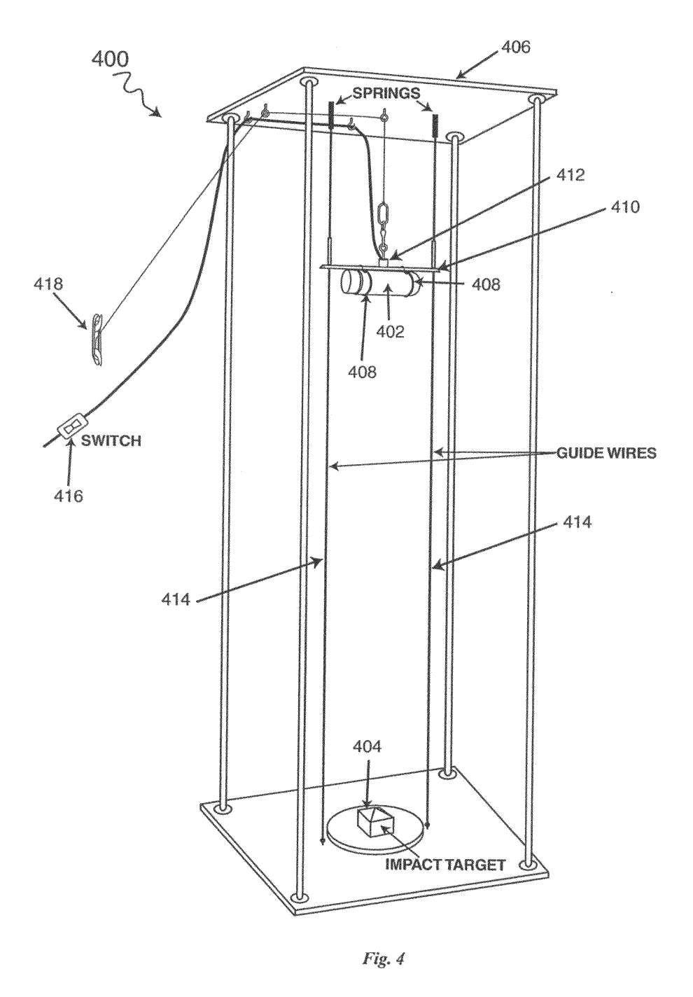

FIG. 4 illustrates another system for puncture testing an aerosol. In system 400, an impact target 404 remains fixed while an aerosol 402 falls. Impact target 404 may be of any shape and made of any material. Outer frame 406 may be made of steel, wood, aluminum or other materials and combinations thereof. The aerosol 402 is attached to a light weight plate 410. Plate 410 may be made from aluminum or other light weight material. The plate 410 may also have holes drilled in it to further reduce weight. In one implementation, aerosol 402 is attached to plate 410 by using rubber bands. In other implementations, ties or clips or other means may be used. Plate 410 has a small piece (small to reduce weight) of steel or any other material with magnetic properties at the center of the plate 410. An electromagnet 412 holds plate 410 in place prior to dropping plate 410. The electric current to electromagnet 412 is controlled by switch 416. The freefall of plate 410 and aerosol 402 is controlled by guides 414. Guides 414 may be wires, strings, rods or tubes which run through openings in plate 410 and extend from the top to the bottom of the outer frame 406. The drop height of plate 410 and aerosol 402 is set by adjusting the length of string 418. The electromagnet 412 is attached to the end of string 418.

In another implementation, aerosol 402 is loosely attached to plate 410. Such a configuration provides greater freedom of movement and less restriction at the moment of impact.

There is little difference in the test results when using the systems shown in FIGS. 3a and 3b versus FIG. 4 as there is no significant difference whether the aerosol falls and strikes an object or the same object, weighing the same as the aerosol, falls and strikes the aerosol. However, systems 300a and 300b of FIGS. 3a and 3b are easier to use and allow greater flexibility in positioning the aerosol at different angles to the dropper than system 400 of FIG. 4.

As previously stated, an IICP does not leave behind any hole or cut to suggest the shape of the object that was hit. Experiments, using the systems described herein, show that any type of focused impact can create an IICP. The degree of focus does not have to be sharp. During testing, many IICPs were created using different objects such as the dull corner of a PVC plumbing fitting, a wood corner, a dull wood pyramid, and the pilot light button from a gas-fired hot water heater.

Experiments using the testing systems described herein also revealed the relative ease with which an aerosol can be punctured. For example, a fall from 4 inches onto an angle iron or 8 inches onto a wood pyramid can puncture an aerosol. Considering that aerosol containers are made from metal, punctures from normal accidental drop heights, like 5 feet or less, would most likely be outside the realm of what a normal consumer would expect, let alone 4 to 8 inches. This is a hidden and unexpected vulnerability in most 3-piece aerosol containers.

When an aerosol falls and hits an object with a particular geometry, it is almost certain to puncture, while other impact geometries do not produce punctures. Also, while some orientations do not lead to puncture, there may be other negative consequences, such as the bottom exploding off if the aerosol lands straight on its bottom or breaking the valve if it lands on the top.

If an ignition source is nearby when an aerosol is punctured, the result can be grievous, both in terms of personal injury and property damage. Thus, any increase in puncture resistance, regardless of impact geometry, would be beneficial to consumer safety. As subsequently discussed, the microstructure of an aerosol's body is highly important for resistance to pure punctures.

Testing of the resistively to puncture completed using the systems described herein revealed that particular aerosol containers are highly resistant to IICP. These types of containers are referred to as “Super Cans.” For example, while other aerosols were readily punctured in a given test configuration from drop heights of 3 feet or less, a Super Can, in the same configuration, withstood impacts from 8 feet without puncture. Such Super Cans were not found in any special aerosol product. As other aerosols from the same product lines did not exhibit the same puncture resistance, the creation of the Super Cans is likely a fluke as opposed to an intentional act. In fact, Super Can is a rare exception.

Tests of the Super Cans show that their chemical composition does not differ significantly from the more puncture-prone aerosol containers. However, metallographic examinations revealed that the Super Cans have a finer, more isotropic microstructure in their wall material than other aerosol containers. Tensile tests on specimens made from Super Cans showed that the stress-strain behavior was characterized by a somewhat higher degree of ductility and toughness in both the circumferential and longitudinal direction.

Given the difference found in the microstructure of such Super Cans, the inventor believes that such properties could be caused by the steel sheet being hot rolled as the final rolling step or otherwise heat treated.

Specifically, the microstructure of the Super Cans can occur where the steel sheet has been heat treated for 1-600 seconds at a temperature that is at or above the recrystallization temperature but below the pearlite-to-austenite transformation range followed by rapid cooling or quenching, i.e., immediate or nearly immediate cooling of the steel in, for example, a fluid bath.

Recrystallization is a process where by minute crystals appear in a material's microstructure, particularly in areas where the grain of the material is significantly deformed. The term “recrystallization temperature” is understood in the art as referring to the approximate temperature at which a highly cold worked material completely recrystallizes upon appropriate heat treatment. For steel, the recrystallization temperature is understood to be approximately 1000° Fahrenheit.

Similarly, it is well known in the art that pearlite refers to a structure of alternate layers of alpha-ferrite and cementite (also known as iron carbide) that can form in some steels that have been slowly cooled. Thus, Austenite refers to a metallic non-magnetic solid solution of iron and an alloying element. The pearlite-to-austenite transformation refers to the break down of the alternating layers. For steel, it is understood that the pearlite-to-austenite transformation occurs at approximately 1333° Fahrenheit.

The same results as the heat treatment described above also can be achieved by process annealing. Process annealing is generally used to soften and increase the ductility of cold worked material. The desired isotropic microstructure can be produced by hot rolling the steel sheet used to make the Super Can for a short period of time during the steel sheet's final rolling passes. Thus, in one embodiment, hot rolling the steel sheet proceeds at a temperature and for a period of time effective to produce the desired isotropic microstructure after the steel sheet already has undergone a plurality of rolling passes, wherein the time ranges from 1 second to 600 seconds and the temperature ranges from about 1000° F. to about 1333° F.

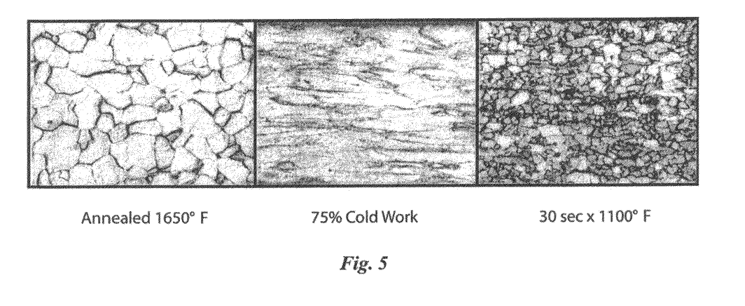

The exact length of time needed for the heat treatment to achieve the microstructure of the Super Can depends upon the carbon content, thickness of the steel sheet, and degree of cold work that precedes the heat treatment. This time can be determined for a particular steel sheet using methods well known in the art and by using metallography to check the microstructure after particular treatment conditions. For example, FIG. 5 illustrates the effect on the 1650° Fahrenheit annealed microstructure of 75% cold work by rolling and then heating at 1100° Fahrenheit for 30 seconds. The micrographs reveal that the annealed isotropic microstructure becomes anisotropic upon cold working, which is then “converted” to an isotropic microstructure after treatment at the conditions of 1100° Fahrenheit for 30 seconds; in other words, the heating at 1100° Fahrenheit for 30 seconds results in an equiaxed microstructure that strongly correlates with “Super Can”-type puncture resistance.

The experimental evidence indicates that Super Cans possess a high degree of resistance against IICP and also pure puncture. Given that the identified Super Cans went through the typical aerosol manufacturing process, purposefully manufacturing Super Cans should not present any manufacturing difficulties or economic barriers that would prevent their use in improving aerosol safety.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of testing a pressurized container for puncture resistance, comprising:
positioning the pressurized container at an end of a chute, wherein the chute guides the fall of an impact member; and
releasing the impact member such that the impact member impacts the pressurized container at said end of chute.

2. The method of claim 1, further including adjusting a height of said impact member.

3. The method of claim 2, wherein said height adjustment includes positioning said impact member upon a movable dowel positioned within said chute.

4. The method of claim 1, wherein the pressurized container is a self-pressurized container.

5. The method of claim 1, further including attaching an impact object to the impact member.

6. A method of testing a pressurized container for puncture resistance, comprising:
attaching the pressurized container to a dropping member; and
releasing the pressurized container such that the pressurized container impacts an object.

7. The method of claim 6, wherein the pressurized container is a self-pressurized container.

8. The method of claim 6, further including:
attaching the pressurized container to the dropping member, wherein the dropping member contains magnetic material; and
releasing the dropping member by controlling an electric current to the electromagnet.

9. The method of claim 8, further including using a switch to control the electric current to the electromagnet.

10. The method of claim 6, further including attaching the dropping member to a guide, the guide being capable of directing a fall of the dropping member.

11. A pressurized container testing system, comprising:
an enclosure having a chute; and
a impact member capable of falling through the chute and impacting with the pressurized container.

12. The system of claim 11, further including a rising member, the rising member being attached to the impact member and being capable of raising the impact member after the impact member has fallen.

13. The system of claim 11, further including an impact object attached to the impact member.

14. The system of claim 11, wherein the enclosure has an opening such that the pressurized container is placed inside the chute.

15. The system of claim 11, wherein the impact member has an adjustable weight.

16. The system of claim 11, wherein the pressurized container testing system further includes
a plurality of opposing openings aligned in a first side and a second side of the enclosure, the first side being opposite to the second side;
a movable positioning member, the movable positioning member being capable of being inserted into the plurality of opposing openings and supporting the weight of the impact member.

17. A pressurized container testing system, comprising:
a pressurized container;
a dropping member capable of holding and releasing the pressurized container; and
an impact object, the impact object being placed such that when the pressurized container is released with the dropping member, the pressurized container will free-fall and land on the impact object.

18. The system of claim 17, wherein the pressurized container is a self pressurized container.

19. The system of claim 17, wherein the dropping member is attached to a guide, the guide capable of directing free-fall of the dropping member.

20. The system of claim 17, further including an electromagnet capable of attaching to the dropping member.

21. The system of claim 20, further including a switch capable of controlling an electric current to the electromagnet.
